(19) United States
(12) Patent Application Publication
(10) Pub. No.: US 2010/0026007 A1
(43) Pub. Date: Feb. 4, 2010

(54) Apparatus and method for harvesting wind power using tethered airfoil

(76) Inventor: Joeben Bevirt, Santa Cruz, CA (US)

Correspondence Address: MICHAEL A. GUTH, 2-2905 EAST CLIFF DRIVE, SANTA CRUZ, CA, 95062, US

(21) Appl. No.: 12/456,694

(22) Filed: Jun. 19, 2009

Related U.S. Application Data
(60) Provisional application No. 61/073,996, filed on Jun. 19, 2008.

(51) Int. Cl. F03D 9/00; B64C 31/06; F03D 5/00

(52) U.S. Cl. 290/55; 244/155 A; 244/154; 244/153 R

(57) ABSTRACT

A wind energy generator for employment in the jet stream or other wind conditions is described herein. The craft comprises a “kite” configured with an airfoil and tethered to a ground based power generator. The craft and tether are configured to pull on the tether during a flight pattern calculated to pull on the tether that is connected to the generator to enable power generation. Also, an aerodynamically stable tether configuration is used and can be supplemented with a number of periodically spaced control surfaces arranged at various points along the tether. These control surfaces can be selectively actuated to stabilize and position the tether. The tether can comprise a two-stage tether having an inelastic portion attached to a pool and an elastic portion that connects with the kite. Also, the invention contemplates a system of wind detection devices that identify the local wind variations and through control systems enable the optimal positioning of the kite.

### CROSS-REFERENCE TO RELATED APPLICATIONS

This application claims priority to U.S. Provisional Application No. 61/073,996, to Bevirt, filed Jun. 19, 2008.

### TECHNICAL FIELD

The invention described herein relates generally to wind power generation. In particular, the invention relates to devices and methods used for launching and retrieving wind energy generating craft as well as novel constructions of such craft. These craft are intended for electrical power generation utilizing the wind energy collected from air currents including the jet stream.

### BACKGROUND

The generation of electricity from conventional ground based devices has been under study for some time. However, it is only recently that such approaches present commercially viable methods for power generation. However, such ground based electrical generation devices are somewhat hampered by the low power density and extreme variability of natural wind currents (in time and space) at low altitudes. For example, typical average energy density at the ground is less than about 0.5 watts per square meter (W/m²). In contrast jet stream energy densities can average about 10 W/m². Thus, at higher altitudes wind generated power becomes an economically feasible alternative using existing technologies to generate power on an economically sustainable scale. The apparatuses and methods disclosed here present embodiments that can access high altitude wind currents and use the higher energy densities to produce power.

Others have explored the idea of using tethered “kites” to generate power. Examples of this principle are described in many papers. In one example Miles Loyd describes an approach for generating “Crosswind Kite Power” (J. of Energy Vol. 4, No. 3. May-June 1980). Also, “Optimal Crosswind Towing and Power Generation with Tethered Kites” (Williams et al., Journal of Guidance, Control, and Dynamics, Vol. 31, No. 1, January-February 2008) addresses the concept. As does “Optimal Control for Power Generating Kites” (Houska B., Diehl M., Internal Report 07-98, ESAT-SISTA, K.U.Leuven (Leuven, Belgium), 2007. Accepted for publication in European Control Conference, Kos, 2007). These publications provide much explanatory background and are hereby incorporated by reference.

However, the inventors have determined that many problems needed to be solved and much work was needed beyond the basic ideas discussed in the papers above. Accordingly, the present disclosure examines some of these problems and suggests several novel solutions to these and other problems. Accordingly, embodiments of the invention present solutions to some of the extent problems associated with existing wind powered electricity generation approaches.

### SUMMARY OF THE INVENTION

In accordance with the principles of the present invention, a variety of wind power generating kites and associated features are disclosed.

In one embodiment, the invention comprises a craft tetherable to a energy generation device. The craft comprises a “kite” configured with an airfoil and tethered to a ground based power generator. The craft and tether are configured to pull on the tether during a flight pattern calculated to pull on the tether that is connected to the generator to enable power generation. The kite can include a vertical stabilizer plane or transverse airfoil enabling added aerodynamic stability during operation In another embodiment, the tether is movably attached to kite at a position below the center of lift for the kite. By moving the attachment point relative to the center of lift the aerodynamic properties of the kite can be altered to control the kite.

The invention further includes a kite embodiment that operates as a tethered turbine blade. Such embodiment includes an airfoil that can be operable as a turbine blade. In some embodiments, the turbine blade includes a single narrow shaft having airfoil shaped ends that operate as the turbine blade aerodynamic surfaces. To increase efficiencies and performance, the blade ends can be configured as variable pitch devices. A bridle is attached to the kite and attached to the tether using a rotatable attachment point.

In another embodiment, a novel tether configuration is disclosed. In one embodiment, the tether is aerodynamically stable having an airfoil shaped cross-section. Additionally, the tether can be constructed to include a number of periodically spaced control surfaces arranged at various points along the tether. These control surfaces can be selectively actuated to stabilize and position the tether. Also, an embodiment of the tether comprises a two-stage tether having an inelastic portion attached to a pool and an elastic portion that connects with the kite.

Also, the invention contemplates a system of wind detection devices that identify the local wind variations and through control systems enable the optimal positioning of the kite.

These and other aspects of the present invention are described in greater detail in the detailed description of the drawings set forth hereinbelow.

### BRIEF DESCRIPTION OF THE DRAWINGS

The following detailed description will be more readily understood in conjunction with the accompanying drawings, in which:

FIG. 1 is a simplified perspective view of an embodiment of kite and wind power generation system in accordance with the principles of the invention.

FIG. 2 is a perspective view of an embodiment of a power generation craft having a vertical stabilizer airfoil in accordance with the principles of the invention.

FIGS. 3(a)-3(b) are side views of an embodiment of a power generation craft having a movable tether attachment point in accordance with the principles of the invention

FIG. 4 is a simplified perspective view of an embodiment of kite functional as an airborne turbine blade in accordance with the principles of the invention.

FIGS. 5(a)-5(c) are simplified depictions of a variety of tether systems and associated control features for stabilizing some tether embodiments of the present invention.

FIG. 6 is a simplified view of a two-stage tether system and an associated power generation and control system for power generating kites of the invention.

It is to be understood that, in the drawings, like reference numerals designate like structural elements. Also, it is understood that the depictions in the Figures are not necessarily to scale.

### DETAILED DESCRIPTION OF THE DRAWINGS

The present invention has been particularly shown and described with respect to certain embodiments and specific features thereof. The embodiments set forth herein below are to be taken as illustrative rather than limiting. It should be readily apparent to those of ordinary skill in the art that various changes and modifications in form and detail may be made without departing from the spirit and scope of the invention.

The following detailed description describes various approaches for putting aloft and recovering wind-energy harvesting devices. Such devices can be employed at many altitudes, but of particular utility when used to generate electrical power when positioned in the jet stream. Some of the embodiments described here make use of kites having airfoil lifting members. Such craft can also make use of launch and retrieval platforms including raise platforms that are elevated some distance above the ground.

The jet stream includes a family of fast flowing, relatively narrow air currents found in the atmosphere around 10 kilometers above the surface of the Earth. They form at the boundaries of adjacent air masses with significant differences in temperature, such as the polar region and the warmer air to the south. The jet stream is mainly found in the tropopause, at the transition between the troposphere (where temperature decreases with height) and the stratosphere (where temperature increases with height). The wind velocity in the jet stream, although variable, is generally quite high. These speeds can vary with temperature gradient, altitude and locations and can range from 55 kilometers per hour (kph) to over 400 kph. A common mean range for jet stream velocities is in range from about 110 kph to 140 kph. These jet streams present a vast untapped potential for wind generated energy. In fact it is estimated that wind energy derived from the jet stream can produce 50 times more energy than terrestrial wind for a given wind flow cross-section. Thus, the jet stream provides a substantial opportunity for energy harvesting.

In one approach a “kite” is attached to a long tether and allowed to gain altitude. As the kite gains altitude it applies forces on the tether. As the force applied by the kite continues, more and more of the tether is played out. The tether can be attached to an energy generator which generates electrical energy as a tether is played out. In a typical embodiment, the generator includes a large reel of tether which spins in one direction as the tether is played out under force generated by wind energy against the “kite”. Periodically, the kite can change its flight profile (e.g., angle of attack or other flight characteristics) to remove tension from the tether. When the tension is removed, the tether is reeled in using relatively little energy. Once the kite is reeled in a desired amount, the kite is maneuvered into a different flight profile enabling the wind generated force to again be applied to the kite. Various flight patterns can be used to effectively generate power. Examples include crosswind flight patterns such as “figure eight” patterns and so on. In any case the playing out and reeling in of the tether can be applied repeatedly for long periods of time enabling extensive power generation. This effect is magnified when the kite is flown into the jet stream.

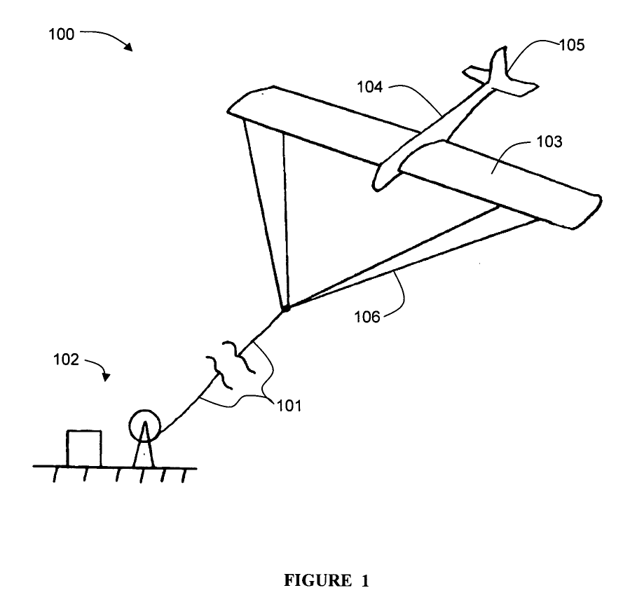

As shown in FIG. 1, the inventor contemplates a kite 100 configured to generate wind energy. The kite 100 can be constructed in many different configurations having a wide range of aerodynamic and flight characteristics and properties. Accordingly, the kite 100 depicted here as a substantially aircraft-shaped apparatus should serve as an example, but kites constructed in accordance with the principles of the invention are not limited to the depicted exemplar shape. The kite 100 is attached to a tether 101 which is moored to an energy generator 102 which can be located on the ground.

In the depicted embodiment, the kite 100 includes a wing 103 mounted to a minimal fuselage 104 which further includes an empennage 105 for added stability. In the depicted embodiment, the tether 101 is attached to the craft using a bridle assembly 106, which in this depiction is affixed to the wings to provide a stable attachment to the craft 100. Many different bridle 106 configurations can be used to secure the craft 100 to the tether 101 and the invention should not be limited to only the depicted embodiments. The inventors contemplate that for enhanced performance the wing 103 of the kite 100 can be configured with ailerons and/or other control surfaces. Additionally, although rigid wings 103 are believed to provide the best performance the inventor appreciates that non rigid wings can be employed in some embodiments.

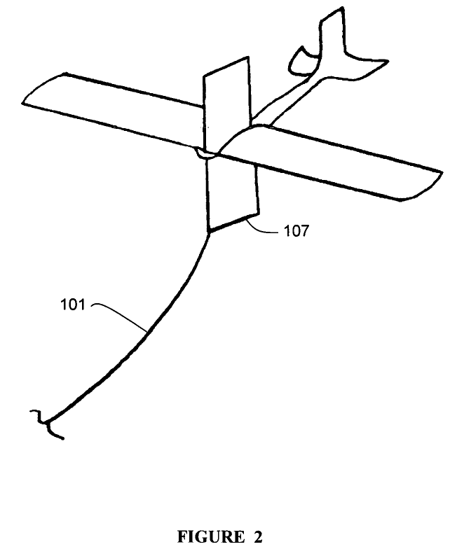

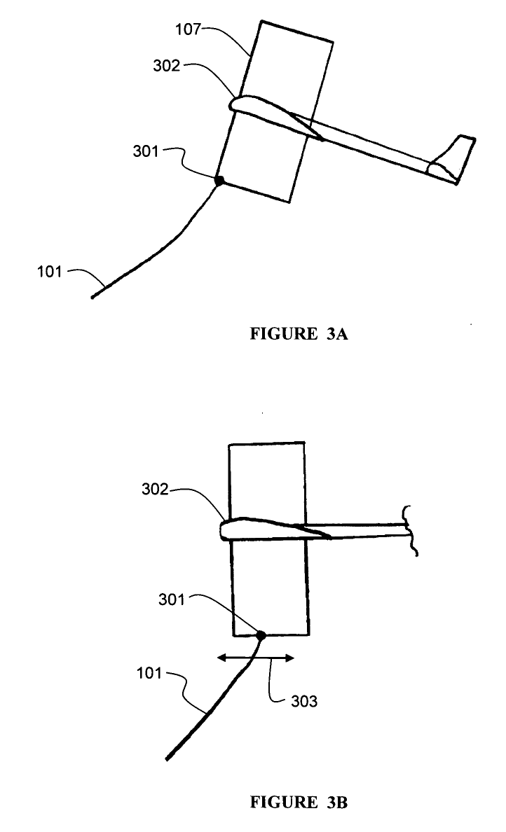

As figuratively depicted in FIG. 2, some kite embodiments can incorporate a transverse airfoil 107 to enhance the performance of the kites. Such airfoils 107 can be symmetric or have alternative wing geometries. Additionally, if desired, in such embodiments the tether 101 can be secured to a bottom portion of the transverse airfoil 107. An advantage to such an implementation is shown and described with respect to FIGS. 3(a)-3(b). In one embodiment, the attachment point 301 for the tether 101 can be movable. For example, the attachment point 301 is arranged at a bottom surface of the transverse airfoil 107. Such implementations have the advantage of mounting the tether 101 below the center of lift 301 for the kite 100. In addition to making a stable platform, such mounting enables the tether 101 to affect flight characteristics by moving the attachments point relative to the center of lift 302. By moving the attachment point 303 backward or forward the angle of attack for the wing 103 can be adjusted readily and quickly. The inventor understand that many methods known to those having ordinary skill in the art enable the tether to be moved back and forward as needed. For example, a small motor can be employed and actuated using wireless of wired signal.

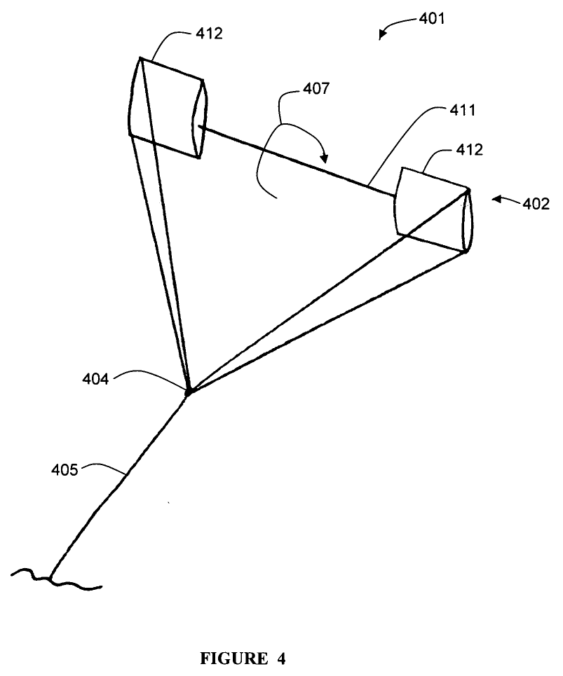

In another approach, a novel kite configuration can operate much like a large suspended windmill. FIG. 4 shows a large kite 401 that can operate much like a single suspended turbine blade. Thus, an airfoil 402 that comprises the kite 401 is affixed to a freely rotatable bridle 403 attached to a spindle 404 at the end of a tether 405. The long tether 405 enables the kite to be flown to high operational altitudes. In certain modes of operation, the kite 401 rotates 407 in a pattern analogous to that of a ground based turbine blade. In common usage this rotational motion is also complemented by a carefully chosen flight pattern designed to maximize energy production. Although many different blade 402 configurations can be employed in accordance with the principles of the invention, the depicted embodiment provides an apparatus that is lightweight, strong, and efficient. The depicted embodiment takes advantage of the fact that the greatest efficiencies in turbine blade operation are attained near the ends of the turbine blades (where the torque is highest). Thus, this depicted embodiment includes an airfoil 402 having airfoils or blade ends 412 arranged at the ends of a blade shaft 411. Although embodiments using standard configuration turbine blades are also contemplated by the inventor, the depicted embodiment presents some compelling advantages. For one, the properties of the kite 401 can be altered using variable pitch blade ends 412 which can be adjusted together or independently. Such variable pitch can alter the lift and drag characteristics of the kite to alter flight patterns and performance as well as move the kite. Such variable pitch can be enabled by small actuators or motors in the shaft 411 and/or the blade ends 412. By having lift surfaces focused substantially at the blade ends 412 the less efficient portions of the turbine blades (i.e., the slower moving portions near the center of blade rotation) can be made smaller and lighter, thereby lightening the overall weight of the kite while still maintaining the highest performance portions of the airfoil 402. This is seen as a substantial design advantage.

Using any of the kite designs contemplated herein, the inventor points out that very large kites can be used with substantial economies of scale as well as increased energy generation potential. Kite wingspans of 200 and greater are seen as advantageous although less massive kites can be used with great utility. This puts such large kites in the same size range as aircraft like the 747 and the C-5A. Such large size is generally associated with wings and fuselage of substantial inner volume dimensions. The inventor contemplates that such internal kite volume can be filled with a low density gas that is lighter than air. Helium probably presenting the best candidate. Although heated gases can also be used, substantial weight increases can be expected due to the need for heating equipment and fuel. Moreover, the heating of such gases requires the continuous expenditure of heat energies. Additionally, many flammable gases can also be used to decrease relative weight of the kite. However, such gases are either highly flammable (e.g., hydrogen, boranes, methane, etc.) and/or of such a high molecular weight as to not provide a substantial enough increase in buoyancy (e.g., neon, ethylene, acetylene, etc.). The inventor points out that kites can also be non-rigid kite structures that can be filled with lighter than air fluids and used in place of the heretofore described rigid kite structures.

An additional point worth considering is as the size of the kites are so large they can be expected to place a rather large load on the supporting tether and bridle systems used to connect the kites with the power generation apparatus. Moreover, in order to stabilize the kites in the jet stream or at high altitudes in general, long lengths of tether are required. This is further exacerbated by the need for long tethers to maximize the energy generation capabilities of such kites. Such long tethers must overcome a number engineering challenges including the need for sustain the varying tensile forces on the tether as well as aerodynamic considerations over the length of a very long cable (in some cases as long as 17 miles).

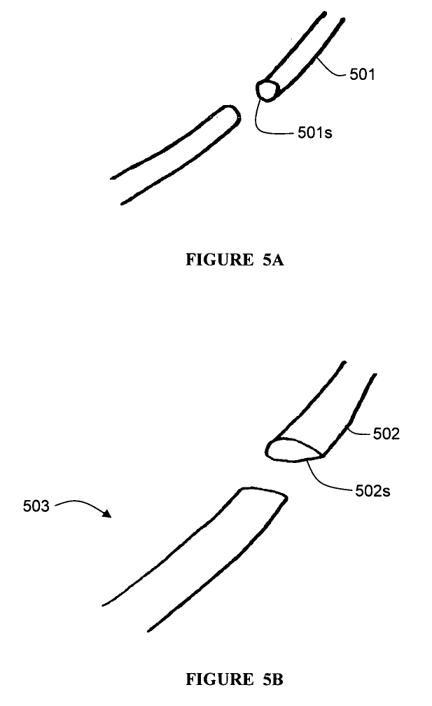

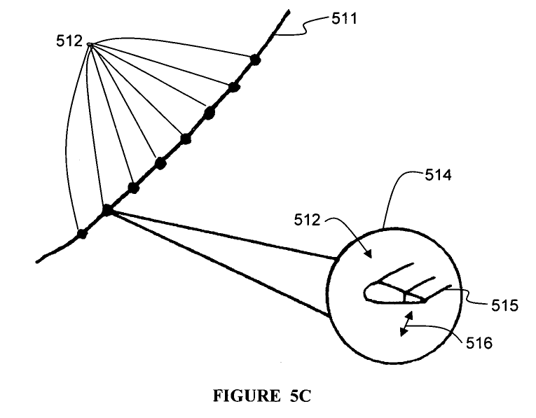

With reference to FIG. 5(a), the inventor has recognized that standard tethers 501 having a circular or cylindrical cross-section 501s exhibits poor aerodynamic performance characterized by high aerodynamic drag and poor stability. The inventor proposes that tether can be constructed as an inherently stable line of as a dynamically stable line. Additionally, the tether can comprise as much as 70% of the total drag of the system. Also, the tether can de designed with a reduced drag aerodynamic profile. In one embodiment FIG. 5(b) illustrated a tether having a low drag aerodynamic profile. The aerodynamic tether 502 has a cross-section 502s that is shaped like an airfoil. Moreover, the tether 502 is arranged so that the relative wind 503 is directed over the airfoil to generate a very stable tether that is not subject excessive flutter, vibration, and other aerodynamic instability characteristics. Additionally, the inventor contemplates that tether stability can be improved by the placement of a number of actuateable stabilizer elements along the length of the tether. For example, FIG. 5(c) schematically depicts a portion of a tether 511 having a plurality of stabilizer elements 512 that are arranged at spaced intervals so that the can be selectively and periodically actuated to affect the flight characteristics of the tether. The window 514 provides an expanded cross-section view of a stabilizer element 512 used in accordance with the principles of the invention. The element 512 can include a tail portion 515 that can be moved 516 to alter the flight profile of an associated point of the tether 511. A wide range of relatively small actuators can be employed. Small motors, piezoelectric actuators, and many other can be used. Additionally, small local sensors can be used to provide the desired sensing and feedback data to enable the correct actuation of the movable tail stabilizer element 515. Additionally, actuation can be initiated from ground based units.

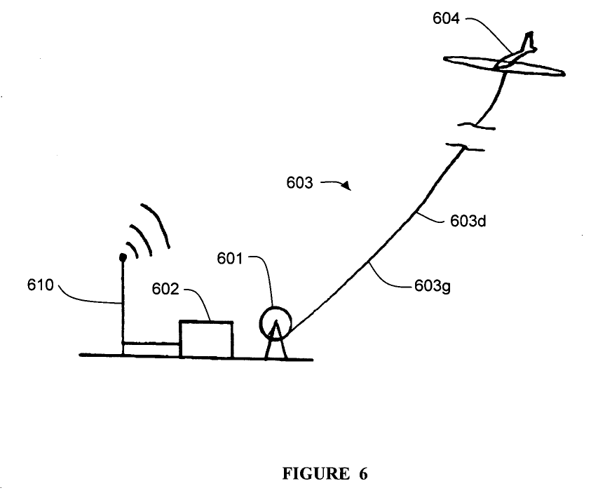

Another tether related issue is the forces exerted on the cables. As previously mentioned the dynamic tension on the tether can vary substantially with the highest forces being generated as the tether is played out under high load and with reduced force as the tether is reeled in under substantially reduced load. This variance in load can prove problematic for a number of reasons which will be explained briefly. In one implementation, the tether is wound around a large spool which is played out as the wind pulls the kite down wind. This puts the tether under substantial tension which, in the case of an elastic tether, tightens the tether around the spool. As the tether is progressively spooled out and reeled in the tensions on the spool can steadily increase to the point where the tether can snap with catastrophic consequences. The inventors have constructed a two stage tether that can perform elastically and also inelastically. As depicted in FIG. 6, a spool 601 and associated energy generation apparatus 602 is attached to a two-stage tether 603. The energy generation apparatus 602 being capable of generating electrical energy as the tether 601 is played out. The tether 603 is also attached to a kite 604. At the “ground portion” of the tether 603g the tether is constructed of a strong relatively inelastic material such as steel or other associated material having sufficient strength and relatively low elastic modulus (i.e. tensile modulus) preventing excessive tightening around the spool 601. The “ground portion” of the tether 603g can be of any length but the inventor believes that a length of in the range of about 400-500 m is sufficient, enabling enough distance of spooling out and reeling in to enable efficient energy generation. The remaining “dynamic portion” of the tether 603d is attached to the end of the “ground portion” of the tether 603g enabling sufficient elasticity in the tether 603 as a whole to provide optimized operational performance. An example of materials that forms a suitable dynamic portion 603d are materials like Kevlar®, Dyneema®, and the like. On the whole such a two stage tether 603 has better operational performance than a purely steel tether which may be to heavy or a purely dynamic tether which may be susceptible to breakage.

The inventors have also understood that the conditions under which a kite operates can have a substantial effect on the amount of energy harvested through the disclosed kite usage. To this end the inventors have come to understand that local atmospheric conditions (such a wind direction, wind velocity and so on) near the kite can have a large effect on energy generation by the kite. As such the kite can be moved into desired positions and altitude to take advantage of the most advantageous wind conditions. To that end, reference is again made to FIG. 6. As depicted, ground stations 610 can make use of RADAR or other wind detection systems to characterize local wind, weather, and other atmospheric conditions in the general area of the kite. The inventor also understands that many systems can be used to characterize local weather conditions in accordance with the principles of the invention. Examples of detection systems suitable for such uses include, but are not limited to LIDAR (Light Detection and Ranging), SODAR (Sonic Detection And Ranging), wind profilers, and other suitable technologies. Using information obtained from such devices, the kite can be adjusted to set optimal altitude, position, heading, angle of attack, tether length adjustments, tether tension, tether angle, and also to generate a desired flight pattern or energy generation pattern for the kite. Thus, in general, the ground stations 610 can include a detector system for characterizing wind and/or weather conditions and a control system capable of affecting the flight characteristics and flight performance of the kites. These systems can be further supplemented by sensors mounted on the tether and bridle systems of the kite as well as sensors on the kites themselves. For example, air pressure sensors and strain gauges mounted on the craft or the tether/bridle can provide useful input for such control systems.

Another difficulty address in this disclosure is that of take off and landing concerns. Among the many concerns here are the large size of such craft and the difficulties of making such craft airborne in the low wind conditions prevalent at low altitudes. One approach is to launch the kites from raised take off platforms. For example, such platforms could be at least 100 feet high. Platform embodiments raised 100 meters or more off the ground can provide suitable launch and landing environments. Some of the disclosed systems are optimized for operation at high speed wind conditions (e.g., such as can be found in the jet stream). Accordingly, such systems may not perform as well as desired at low wind conditions. The inventor contemplates that one solution to this dilemma is the institution of variable geometry wing configurations that can be optimized for low wind performance at take off and landing and altered wing geometry to achieve a high performance profile for use at higher wind conditions. The variable blade angle embodiments disclosed with respect to, for example, FIG. 4 are examples of this approach.

In another approach a pulley or ramp assisted launch mechanism can be used to accelerate the kite to a sufficient velocity. Alternatively, a pneumatic launch mechanism can be used to accelerate the kite to a sufficient velocity. In another approach a catapult can be used to accelerate the kite beyond its stall speed. A steam-driven catapult such as those used on aircraft carriers may prove suitable. In addition, each of these approaches can be supplemented by mounting the take-off assist devices on an elevated launch platform such as previously discussed.

Similar difficulties can be encountered should the need arise to land the kite. The kite can be configured with remotely operable control elements, much a radio control gliders are flown today. Additionally, a parachute can be deployed and the glider be returned to earth in a parachute descent. Additionally, the tether can be separated from the kite and the tether can be allowed to land using a parachute while the kite glide lands separately. In the same general approach, both the separate kite and tether can be parachute landed if desired. This could be helpful in emergency situations. Additionally, in many situations the kite can be lowered using the tether and simply landed under aerodynamically favorable conditions.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. Also, reference in the claims to an element in the singular is not intended to mean “one and only one” unless explicitly stated, but rather, “one or more”. Furthermore, the embodiments illustratively disclosed herein can be practiced without any element which is not specifically disclosed herein.

What is claimed is:

1. An energy generation system configured to capture wind energy, the system comprising:
an aircraft configured to be positioned in air currents enabling the capture of wind energy;
a tether system that anchors the aircraft when it is airborne;
a power system that enables one of:
(i) the harvesting of wind energy from the aircraft transmitted through the tether to the power system, or
(ii) the capture and transmission of electrical energy generated by the aircraft; and
a control system enabling control of the aircraft and optionally other elements of the system.

2. The energy generation system recited in claim 1 wherein the aircraft includes a tether attachment site for attaching the aircraft to the tether and a tether positioning system configured to enable changes in the flight profile of the aircraft by adjusting the position of the attachment site.

3. The energy generation system recited in claim 2 wherein the aircraft includes a bridle attached to the aircraft and a movable attachment site that is movable across a portion of the bridle enabling changes in the flight profile of the aircraft by adjusting the position of the attachment site.

4. The energy generation system recited in claim 3 wherein the aircraft includes an airfoil having wingtips and wherein the bridle is attached to the airfoil enabling changes in the flight profile of the aircraft by adjusting the position of the attachment site.

5. The energy generation system recited in claim 4 wherein the bridle is attached to the airfoil inward from the wingtips of the airfoil.

6. The energy generation system recited in claim 2 wherein the tether positioning system includes a bridle attached to the tether, the bridle engaged with a pitch control mechanism for adjusting the pitch angle of the aircraft.

7. The energy generation system recited in claim 6 wherein the pitch control mechanism is arranged to move at least one end of the bridle to adjust the position of the tether relative to a center of lift for the aircraft to enable adjustment of the pitch angle of the aircraft.

8. The energy generation system recited in claim 7 wherein the pitch control mechanism moves at least one end of the bridle forward or backward relative to the aircraft to adjust the position of the tether relative to a center of lift for the aircraft to enable adjustment of the pitch angle of the aircraft.

9. The energy generation system recited in claim 1 wherein the aircraft is configured as follows:
a center of rotation having a plurality of rotor blades extending therefrom; and
a bridle having a tether attachment point and affixed to the rotor blades in a manner configured to enable rotation of the rotor blades.

10. The energy generation system recited in claim 9 wherein the pitch of the rotor blades are independently adjustable.

11. The energy generation system recited in claim 10 wherein the plurality of rotor blades comprises two blades.

12. The energy generation system recited in claim 10 wherein the plurality of rotor blades have airfoil shaped lift surfaces.

13. The energy generation system recited in claim 12 wherein only the outer portions of rotor blades have airfoil shaped surfaces.

14. The energy generation system recited in claim 13 wherein said outer airfoil shaped lift surfaces are separated by a support shaft that extends between the airfoil shaped lift surfaces.

15. The energy generation system recited in claim 1 wherein the tether system includes a tether apparatus having an aerodynamic profile configured to reduce drag.

16. The energy generation system recited in claim 15 wherein the tether apparatus is comprised of a high strength low weight material.

17. The energy generation system recited in claim 15 wherein the tether apparatus is weighted to alter the mass of the tether to create increased stability.

18. The energy generation system recited in claim 15 wherein the tether includes a plurality of control surfaces configured to affect a flight profile of the tether apparatus.

19. The energy generation system recited in claim 15 wherein the tether apparatus includes an aerodynamically configured outer shell arranged to reduce the drag of at least one structural core positioned inside the aerodynamically configured outer shell of the tether apparatus.

20. The energy generation system recited in claim 19 wherein the at least one structural core comprises at least one structural support cable.

21. The energy generation system recited in claim 15 wherein the tether apparatus comprises an aerodynamically configured structural support member.

22. The energy generation system recited in claim 21 wherein said aerodynamically configured structural support member include a cavity inside the tether.

23. The energy generation system recited in claim 22 wherein said cavity contains a lighter than air gas.

24. The energy generation system recited in claim 22 wherein said cavity comprises a vacuum filled space.

25. The energy generation system recited in claim 22 wherein said cavity contains a lightweight solid material having less density than the material that forms the aerodynamically configured structural support member.

26. The energy generation system recited in claim 22 wherein said cavity is located in a tail portion of the aerodynamically configured structural support member.

27. The energy generation system recited in claim 26 wherein the tail portion of the aerodynamically configured structural support member includes spaced apart slots arranged to release stresses on the tether.

28. The energy generation system recited in claim 22 wherein the tether includes a tail space in a tail portion of the aerodynamically configured structural support member and a front space in a front portion of the aerodynamically configured structural support member.

29. The energy generation system recited in claim 28 wherein the front and tail spaces are separated by an intervening structural member arranged between the front and tail spaces.

30. The energy generation system recited in claim 29 wherein the front and tail spaces contain at least one of a lighter than air gas, vacuum filled space, or a lightweight solid material having less density than the material that forms the aerodynamically configured structural support member.
